(19) United States
(12) Patent Application Publication
(10) Pub. No.: US 2017/0215387 A1
(43) Pub. Date: Aug. 3, 2017

(54) ANIMAL COLLAR HAVING A TAG HOUSING

(71) Applicant: Amanda Kadell, Lebanon, IL (US)

(72) Inventor: Amanda Kadell, Lebanon, IL (US)

(21) Appl. No.: 15/413,114

(22) Filed: Jan. 23, 2017

Related U.S. Application Data
(60) Provisional application No. 62/290,349, filed on Feb. 2, 2016.

(51) Int. Cl. A01K 27/00; A44B 17/00; A01K 11/00; A44B 18/00

(52) U.S. Cl. CPC A01K 27/008; A44B 18/00; A44B 17/00; A01K 27/001; A01K 11/00

(57) ABSTRACT

An animal collar including a tag housing with a transparent cover. The tag housing is affixed to the collar and adapted to house one or more tags associated with the animal. The transparent cover is adapted to secure the tags against the collar while enabling viewing of information on the tags. A fastener ensures that the tags do not fall out of the tag housing.

### CROSS-REFERENCE TO RELATED APPLICATION

This application claims the benefit of U.S. Provisional Application Ser. No. 62/290,349, filed Feb. 2, 2016, the entire disclosure of which is incorporated herein by reference for all purposes.

### TECHNICAL FIELD

Aspects of the present invention generally relate to animal collars having a tag housing.

### BACKGROUND

Conventional animal collars create potentially unsafe condition for animals because tags (e.g., for identification, rabies vaccination status, etc.) hang from the collar. Hanging tags can snag in a number of potentially dangerous manners, such as entanglement with another animal's hanging tags, which may lead to animal discomfort, stress, injury, and/or death. Moreover, the sound created when multiple hanging tags contact each other can create undesirable audible noise, such as during hunting activities.

Conventional collars attempt to replace hanging tags with embroidered names and attachable pouches to solve the shortcomings of hanging tags. But embroidered collars typically only include the animal's name. Even embroidered collars that include the animal's address and owner contact information still do not address the need to display rabies vaccination tags. And collars with attachable pouches do not address the entanglement issues because the pouch itself may become snagged. Moreover, the pouches are not transparent, which requires humans to approach the animal in order to obtain information on the tags. Aggressive or scared animals may not be comfortable with strangers approaching them to read the tags.

Kelly (U.S. Pat. No. 1,539,744) describes the attachment of animal identification tags to a collar in such a manner that the tags are readily visible and do not make audible noise. One disadvantage of the technique described by Kelly is it requires a housing for each individual animal tag. The procedure to change a tag is inconvenient because the collar must be unbuckled and removed from the animal, the tag housing must be removed from the collar, and the housing must be disassembled.

Cunningham (U.S. Pat. No. 4,178,879) describes a transparent window integral to the collar that permits insertion of an identification strip. One disadvantage of the technique of Cunningham is that it is ill-suited for use with existing animal tags and/or collars because it is designed to be used with flexible, custom-made plastic strips that will be displayed in the collar window.

Castagna (U.S. Pat. No. 5,503,114) describes a specially designed message holder, attachable to a collar, upon which messages can be written. One disadvantage of Castagna is the printed labels may fall out of the disclosed label holding device because of the open slits.

### SUMMARY

Aspects of the present invention described herein enable utilization of existing tags and allow the tags to be visible from a distance without the risk of hanging tags snagging. Accordingly, aspects of the present invention result in a safer collar for the animal. Moreover, aspects of the present invention result in audible noise reduction by eliminating sounds generated by multiple hanging tags contacting each other.

In an aspect, an animal collar includes a collar sized and shaped to fit around the neck of an animal and a tag housing affixed to the collar. The tag housing is adapted to house tags associated the animal. The tag housing includes a transparent cover adapted to secure the tags against the collar and enable viewing of information engraved on the tags. A width of the tag housing is substantially equal to a width of the collar to reduce the likelihood of snagging on an obstacle.

In another aspect, a tag housing includes a housing body, a transparent cover, and a fastener. The housing body is adapted to house tags associated with an animal. The transparent cover is affixed to the tag housing and adapted to secure the tags against an animal collar and enable viewing of information on the one or more tags. The fastener is affixed to the tag housing and adapted to temporarily fasten opposing surfaces of the housing body while pressed together. The fastener is further adapted to permit access to the tags in the area between the animal collar and the transparent cover.

In yet another aspect, an animal collar includes a collar sized and shaped to fit around the animal and a tag housing. The tag housing includes a housing body, a transparent cover, and a fastener. The housing body is affixed around the collar such that the collar extends from a first end of the housing body between a first side and a second side of the housing body to a second end of the housing body. The housing body is adapted to house a plurality of tags associated with the animal between the collar and the first side of the housing body. The transparent cover is affixed to the first side of the housing body. The transparent cover is adapted to hold the tags against the collar and enable viewing of information on the tags. The fastener is affixed to the first side of the housing body substantially near the first end of the housing body. The fastener is adapted to temporarily fasten opposing surfaces of the first side of the housing body while pressed together to reduce the likelihood of the tags exiting the housing body. The faster is also adapted to permit access to the tags in the area between the collar and the transparent cover.

### BRIEF DESCRIPTION OF THE DRAWINGS

FIG. 1 illustrates an exemplary animal collar and tag housing having a hook-and-loop fastener according to an embodiment.

FIG. 2 illustrates an exemplary sliding capability of the animal collar of FIG. 1.

FIG. 3 illustrates the hook-and-loop fastener of the animal collar of FIG. 1.

FIG. 4 illustrates an exemplary animal collar and tag housing having a snap fastener according to an embodiment.

FIG. 5 illustrates another exemplary animal collar and tag housing according to an embodiment.

### DETAILED DESCRIPTION

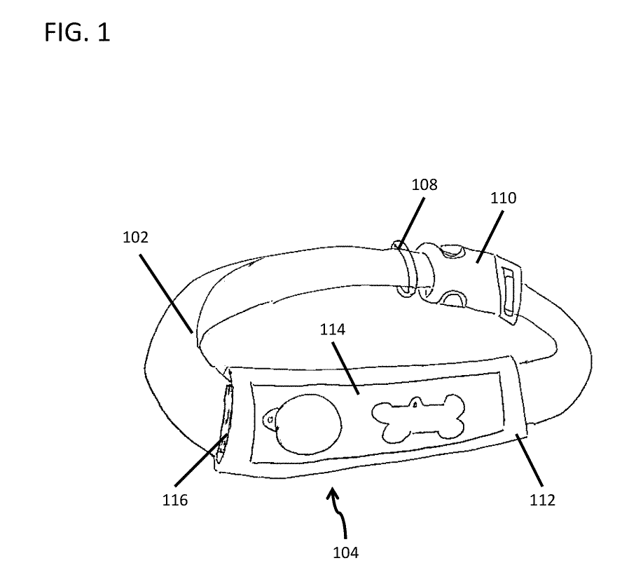

FIG. 1 illustrates an exemplary animal collar 102 and tag housing 104 in accordance with an embodiment of the invention. The collar 102 includes a leash loop 108 and a locking mechanism 110. The tag housing 104 includes a housing body 112, a transparent cover 114, and a hook-and-loop fastener 116.

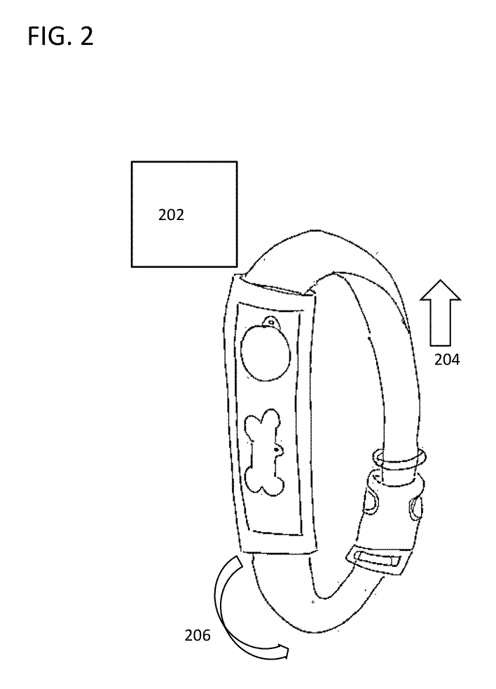

The tag housing 104 is adapted to affix to the animal collar 102 and house animal tags, such as those for animal identification, vaccination status, law enforcement badges, and the like. In an embodiment, the tag housing 104 (e.g., housing body 112, transparent cover 114, etc.) enables utilization of existing animal tags and/or existing collars (e.g., animal collar 102) while allowing the tags to be visible from a distance without the risk of injury to the animal from snagging tags. In another embodiment, the tag housing 104 also reduces the likelihood of injury to the animal by sliding along animal collar 102 when it becomes tangled and/or obstructed, as illustrated by FIG. 2. For instance, instead of snagging when encountering an obstacle 202 (e.g., another animal, another animal's tags, a piece of furniture, etc.) while moving in direction 204, the tag housing 104 may slide along the animal collar in direction 206.

Referring again to FIG. 1, the housing body 112 is adapted to affix around animal collar 102. In an embodiment, the housing body 112 has a width, W_{HB}, substantially equal to the width, W_{c}, of the animal collar 102 to prevent the tag housing 104 from snagging. For example, the width of the housing body 112 may exceed the width of the animal collar 102 only by the thickness of the material comprising the housing body 112. The width of the housing body 112 may alternatively exceed the width of the animal collar 102 by a few (e.g., about three or less) centimeters. In an embodiment, a length of the housing body 112 is long enough to accommodate a plurality of animal tags. For example, the housing body 112 may accommodate both an identification tag and a rabies vaccination tag. The housing body 112 may be comprised of vinyl polymers, leather, artificial leather (e.g., bicast leather, etc.), plastic, or the like and/or combinations thereof.

The transparent cover 114 is adapted to provide pressure against the tags to keep them pressed against animal collar 102 and allow textual and/or graphical information on the tags to be viewed by a human without opening tag housing 104. In an embodiment, the transparent cover 114 has a width, W_{TC}, equal to or greater than the width, W_{AT}, of the animal tag and less than the width of the housing body 112, W_{HB}. Moreover, the length of the transparent cover 114 is long enough to accommodate a plurality of animal tags while still being less than the length of the housing body 112 in accordance with an embodiment of the invention. The transparent cover 114 may be comprised of transparent plastic, transparent vinyl polymers, and the like and/or combinations thereof.

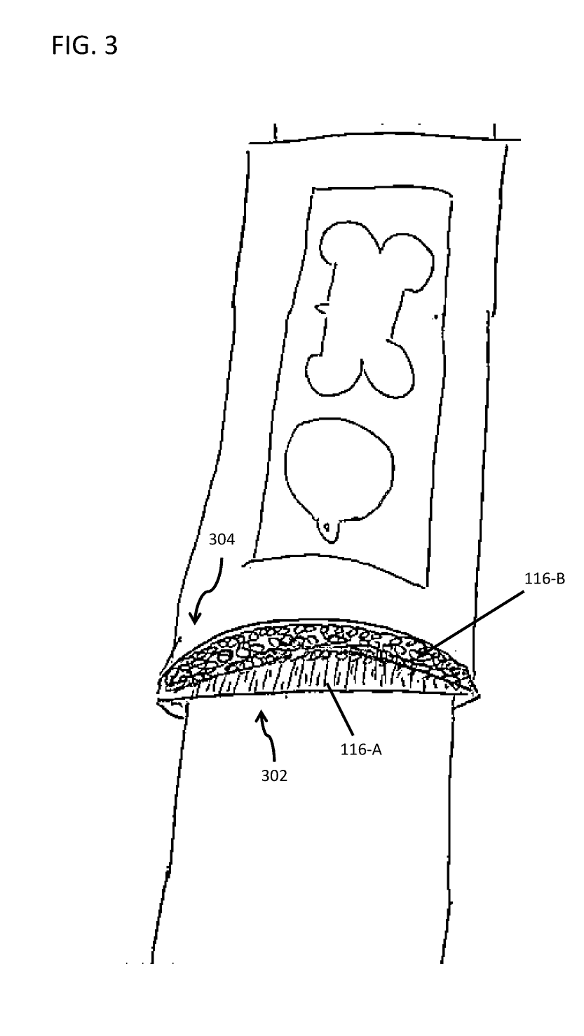

The hook-and-loop fastener 116 (e.g., Velcro, etc.) is adapted to temporarily fasten opposing surfaces of housing body 112 while pressed together and permit access to the area between animal collar 102 and transparent cover 114 (e.g., for insertion or removal of the animal tags). As illustrated by FIG. 3, a hook portion 116-A is attached (e.g., sewn, glued, etc.) to a first surface 302 of the housing body 112 and a loop portion 116-B is attached (e.g., sewn, glued, etc.) to an opposing second surface 304 of the housing body 112. In one or more embodiments, the hook portion 116-A may instead be attached to the opposing second surface 304 of the housing body and the loop portion 116-B may instead be attached to the first surface 302 of the housing body 112.

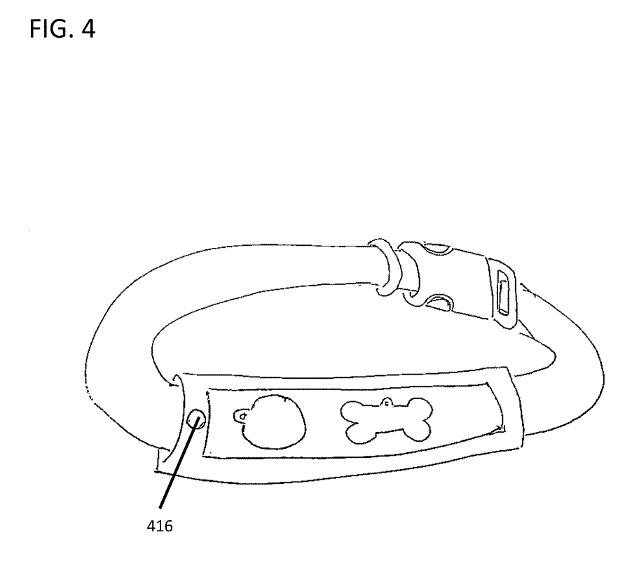

FIG. 4 illustrates another exemplary embodiment of the tag housing 104. The tag housing of this embodiment includes the housing body 112, the transparent cover 114, and a snap fastener 416. The snap fastener 416 is adapted to temporarily fasten opposing surfaces of housing body 112 while pressed together and permit access to the area between animal collar 102 and transparent cover 114 (e.g., for insertion or removal of the animal tags). An exemplary snap fastener includes a pair of interlocking discs (e.g., metal, plastic, etc.) in which a circular lip under one disc fits into a groove on the top of the other disc, holding them fast until a certain amount of force is applied.

The hook-and-loop fastener 116 and snap fastener 416 enable a human to conveniently change tags without unbuckling or removing the collar 102 from the animal or removing the tag housing 104. Moreover, the hook-and-loop fastener 116 and snap fastener 416 ensure that the animal tags do not fall out of the tag housing 104. Although the embodiments described herein utilize hook-and-loop fastener 116 and snap fastener 416, one having ordinary skill in the art will understand that other fastening elements may be used without departing from the scope of the present invention.

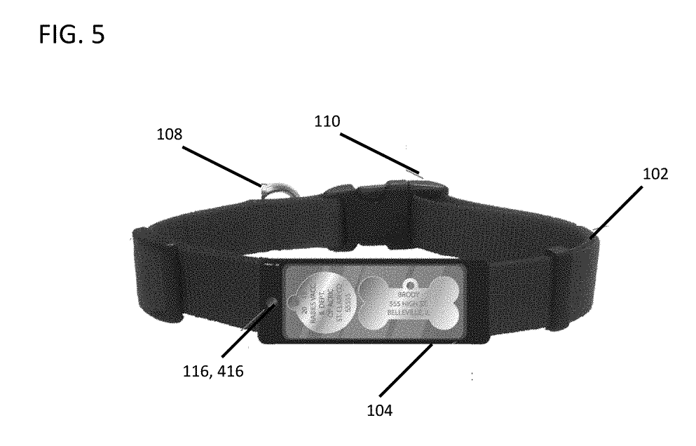

FIG. 5 illustrates another exemplary embodiment of animal collar 102, tag housing 104 (including hook-and-loop fastener 116 and/or snap fastener 416), leash loop 108, and locking mechanism 110 in accordance with an embodiment of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. An animal collar, comprising:
a collar sized and shaped to fit around the neck of an animal; and
a tag housing affixed to the collar, wherein the tag housing is adapted to house one or more tags associated with the animal, wherein the tag housing includes a transparent cover adapted to secure the one or more tags against the collar and enable viewing of information engraved on the one or more tags, and wherein a width of the tag housing is substantially equal to a width of the collar to reduce the likelihood of snagging on an obstacle.

2. The animal collar of claim 1, further comprising a fastener adapted to temporarily fasten opposing surfaces of the tag housing while pressed together and adapted to permit access to the area between the collar and the transparent cover.

3. The animal collar of claim 2, wherein the fastener is a hook-and-loop fastener.

4. The animal collar of claim 2, wherein the fastener is a snap fastener.

5. The animal collar of claim 1, wherein a width of the transparent cover is equal to or greater than a width of the one or more tags and less than the width of the tag housing.

6. The animal collar of claim 1, wherein a length of the transparent cover is long enough to accommodate a plurality of tags and less than a length of the tag housing.

7. The animal collar of claim 1, wherein the tag housing is adapted to slide along the collar when it encounters the obstacle.

8. A tag housing, comprising:
a housing body adapted to house one or more tags associated with an animal;
a transparent cover affixed to the tag housing and adapted to secure the one or more tags against an animal collar and enable viewing of information on the one or more tags; and
a fastener affixed to the tag housing and adapted to temporarily fasten opposing surfaces of the housing body while pressed together and to permit access to the one or more tags in the area between the animal collar and the transparent cover.

9. The tag housing of claim 8, wherein a width of the housing body is substantially equal to a width of the animal collar to reduce the likelihood of the housing body snagging on an obstacle.

10. The tag housing of claim 9, wherein a width of the transparent cover is equal to or greater than a width of the one or more tags and less than the width of the housing body.

11. The tag housing of claim 10, wherein the housing body is affixed around the animal collar.

12. The tag housing of claim 11, wherein the housing body is adapted to slide along the collar when it encounters the obstacle.

13. The tag housing of claim 8, wherein the fastener is a hook-and-loop fastener.

14. The tag housing of claim 8, wherein the fastener is a snap fastener.

15. An animal collar, comprising:
a collar sized and shaped to fit around the animal; and
a tag housing, comprising:
a housing body affixed around the collar such that the collar extends from a first end of the housing body through a first side and a second side of the housing body to a second end of the housing body, the housing body adapted to house a plurality of tags associated with the animal between the collar and the first side of the housing body,
a transparent cover affixed to the first side of the housing body, the transparent cover adapted to hold the plurality of tags against the collar and enable viewing of information on the plurality of tags,
a fastener affixed to the first side of the housing body substantially near the first end of the housing body, the fastener adapted to temporarily fasten opposing surfaces of the first side of the housing body while pressed together to reduce the likelihood of the tags exiting the housing body and to permit access to the one or more tags in the area between the collar and the transparent cover.
